(19) United States
(12) Patent Application Publication
(10) Pub. No.: US 2024/0429563 A1
(43) Pub. Date: Dec. 26, 2024

(54) POWER STORAGE MODULE

(71) Applicant: TOYOTA JIDOSHA KABUSHIKI KAISHA, Toyota-shi (JP)

(72) Inventors: Yosuke SHIMURA, Toyota-shi (JP); Yoshiro OBAYASHI, Toyota-shi (JP); Atsushi YAMANAKA, Nagoya-shi (JP); Masashi CHIHARA, Nagoya-shi (JP); Kazuki SUGIE, Miyoshi-shi (JP); Kosuke YONEKAWA, Nisshin-shi (JP); Yasuhiro HIRAO, Toyota-shi (JP)

(73) Assignee: TOYOTA JIDOSHA KABUSHIKI KAISHA, Toyota-shi (JP)

(21) Appl. No.: 18/665,094

(22) Filed: May 15, 2024

(30) Foreign Application Priority Data
Jun. 23, 2023 (JP) 2023-103353

(51) Int. Cl. H01M 50/502; H01M 50/227; H01M 50/278; H01M 50/293; H01M 50/30; H01M 50/547

(52) U.S. Cl. CPC H01M 50/502; H01M 50/227; H01M 50/278; H01M 50/293; H01M 50/30; H01M 50/547

(57) ABSTRACT

In an accommodation space of a case body of a power storage module, a partition portion forms a first and second compartments adjacent to the first compartment with the partition portion interposed between the first and second compartments. A connection conductive member has a first end portion located at one side in the first direction and embedded in the case body. A second end portion of the connection conductive member is located at the other side in the first direction and embedded in the case body. A first inner surface portion thereof is exposed to the first compartment and electrically connected to a first electrode assembly contained in the first compartment, among a plurality of electrode assemblies. A second inner surface portion thereof is exposed to the second compartment and electrically connected to a second electrode assembly contained in the second compartment, among the plurality of electrode assemblies.

### CROSS REFERENCE TO RELATED APPLICATIONS

This nonprovisional application is based on Japanese Patent Application No. 2023-103353 filed on Jun. 23, 2023 with the Japan Patent Office, the entire contents of which are hereby incorporated by reference.

### BACKGROUND

### Field

The present disclosure relates to a power storage module.

### Description of the Background Art

In the housing of the battery case disclosed in Japanese Patent Laying-Open No. No. 2019-106372, a lower wall and a plurality of (for example, three, four, or more) sidewalls are integrated to form a space inside, an open surface opposed to the lower wall is provided, and one or more (for example, two, three, four, five, or more) partitions are provided in the space. Thereby, the housing includes a plurality of battery compartments separated by one or more partitions disposed in the space. Each battery compartment can accommodate an electrode assembly. The battery case further includes a lid portion for closing the open surface of the housing. The lid portion may have a positive electrode terminal and a negative electrode terminal.

### SUMMARY

As disclosed in Japanese Patent Laying-Open No. 2019-106372, when an electrode assembly is accommodated in each of a plurality of battery compartments, terminals protruding from a lid portion are connected to each other by a connecting member such as a bus bar. By disposing the connecting member outside the case, the size of the power storage module is increased.

The present disclosure is given in view of the above problem, and it is an object of the present disclosure to provide a downsized power storage module.

A power storage module according to the present disclosure includes a plurality of electrode assemblies, a case, and at least one connection conductive member. The plurality of electrode assemblies are arranged in a first direction. The case houses the plurality of electrode assemblies. The connection conductive member is located at a side of the plurality of electrode assemblies in a second direction, and electrically connects together the electrode assemblies adjacent to each other. The second direction is orthogonal to the first direction. The case includes a case body and at least one partition portion. The case body has electrical insulation property and surrounds the plurality of electrode assemblies. The partition portion has electrical insulation property, and is located between the electrode assemblies adjacent to each other to partition an accommodation space of the case body. In the accommodation space of the case body, the partition portion forms a first compartment and a second compartment adjacent to the first compartment with the partition portion interposed between the first compartment and the second compartment. The connection conductive member includes a first end portion, a second end portion, a first inner surface portion, and a second inner surface portion. The first end portion is an end portion, located at one side in the first direction, of the connection conductive member, and embedded in the case body. The second end portion is an end portion, located at the other side in the first direction, of the connection conductive member, and embedded in the case body. The first inner surface portion is exposed to the first compartment and electrically connected to a first electrode assembly contained in the first compartment, among the plurality of electrode assemblies. The second inner surface portion is exposed to the second compartment and electrically connected to a second electrode assembly contained in the second compartment, among the plurality of electrode assemblies.

According to the above configuration, the connection conductive member electrically connects the first electrode assembly and the second electrode assembly and is at least partially embedded in the case body in the first direction. Therefore, the size of the power storage module can be reduced.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view showing a power storage module according to a first embodiment.

FIG. 2 is a partially exploded perspective view of the power storage module according to the first embodiment.

FIG. 3 is a cross-sectional view of the power storage module of FIG. 1 taken along a line III-III.

FIG. 4 is a cross-sectional view of the power storage module of FIG. 1 taken along a line IV-IV.

FIG. 5 is a cross-sectional view of an electrode assembly of the power storage module of FIG. 1 taken along a line V-V.

FIG. 6 is a partially exploded perspective view of a power storage module according to a second embodiment.

FIG. 7 is a partially exploded perspective view of a power storage module according to a third embodiment.

### DESCRIPTION OF THE PREFERRED EMBODIMENTS

Embodiments of the present disclosure will be described with reference to the drawings. In the drawings referred to below, the same or corresponding members are denoted by the same reference numerals.

### First Embodiment

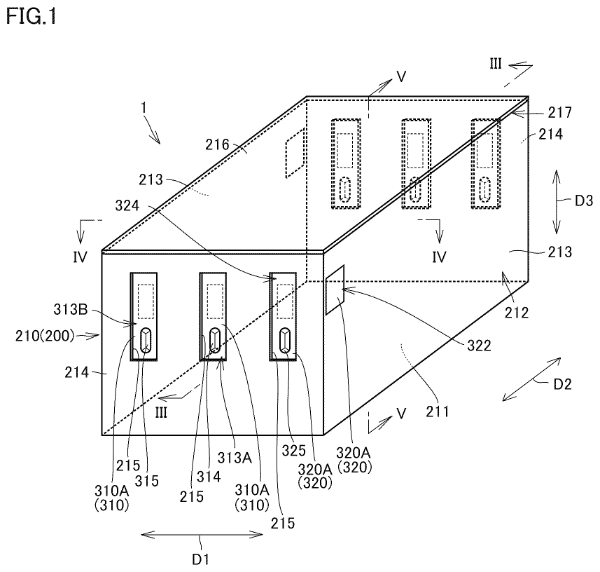

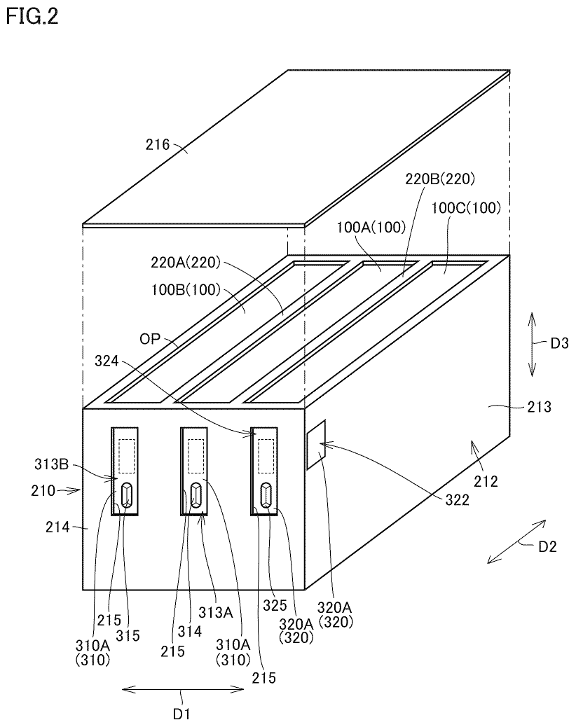

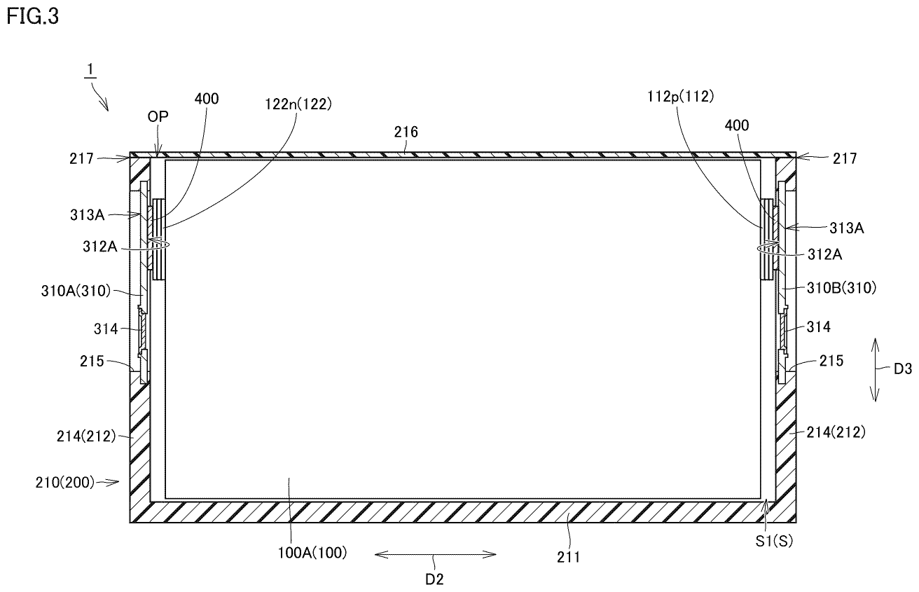

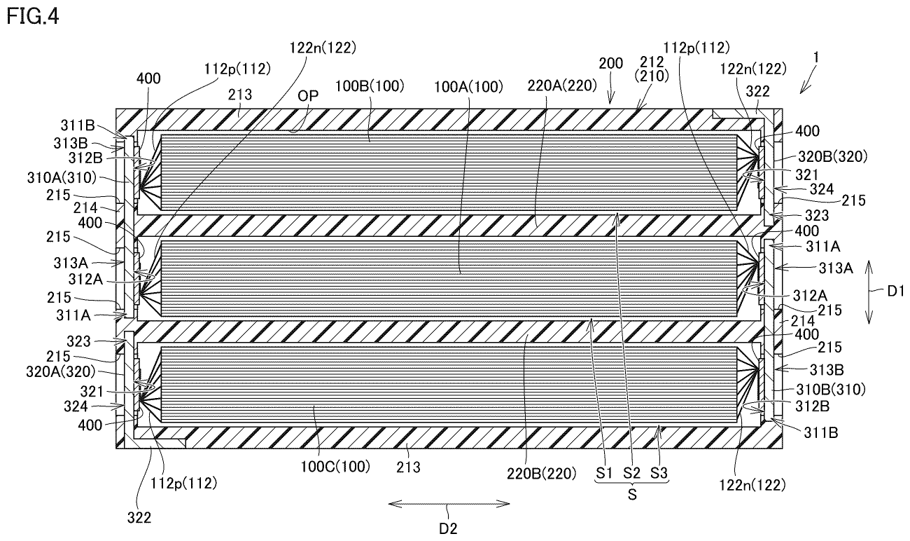

FIG. 1 is a perspective view showing a power storage module according to a first embodiment. FIG. 2 is a partially exploded perspective view of the power storage module according to the first embodiment. FIG. 3 is a cross-sectional view of the power storage module of FIG. 1 taken along a line III-III. FIG. 4 is a cross-sectional view of the power storage module of FIG. 1 taken along a line IV-IV.

As shown in FIGS. 1 to 4, a power storage module 1 according to a first embodiment of the present disclosure includes a plurality of electrode assemblies 100, a case 200, at least one connection conductive member 310, and an external conductive member 320. A plurality of electrode assemblies 100 are arranged in the first direction D1. The case 200 houses a plurality of electrode assemblies 100. The connection conductive member 310 is disposed at a side of the plurality of electrode assemblies 100 in the second direction D2, and electrically connects the electrode assemblies 100 adjacent to each other. The second direction D2 is orthogonal to the first direction D1.

In this embodiment, the plurality of electrode assemblies 100 include a first electrode assembly 100A, a second electrode assembly 100B, and a third electrode assembly 100C. The third electrode assembly 100C is located opposite to the second electrode assembly 100B when viewed from the first electrode assembly 100A. In the present embodiment, the second electrode assembly 100B is located at an endmost position in the first direction DI among the plurality of electrode assemblies 100. Among the plurality of electrode assemblies 100, the third electrode assembly 100C is located at an endmost position in the first direction D1 and opposite to the second electrode assembly 100B. The plurality of electrode assemblies 100 may include four or more electrode assemblies.

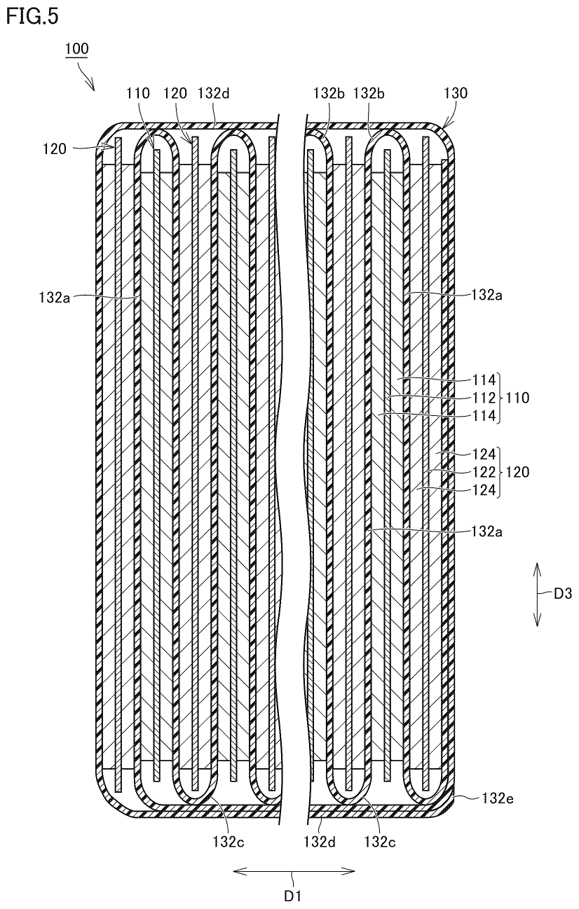

FIG. 5 is a cross-sectional view of the electrode assembly of the power storage module of FIG. 1 taken along a line V-V. As shown in FIG. 5, each of the plurality of electrode assemblies 100 includes a plurality of electrodes 110 and 120 and a separator 130. In this embodiment, the electrode assembly 100 is an electrode assembly for a secondary battery such as a lithium-ion secondary battery.

As shown in FIG. 5, the plurality of electrodes 110 and 120 are arranged in the first direction D1. The plurality of electrodes 110 and 120 have a plurality of positive electrodes 110 and a plurality of negative electrodes 120.

Each positive electrode 110 is formed in a rectangular shape elongated in the second direction D2. Each positive electrode 110 includes a positive electrode current collector foil 112 and a positive electrode active material layer 114 provided on both surfaces of the positive electrode current collector foil 112. The positive electrode current collector foil 112 has a positive electrode tab 112p (see FIGS. 3 and 4) in which the positive electrode active material layer 114 is not provided. The positive electrode tab 112p protrudes toward one side in the second direction D2.

Each negative electrode 120 is formed in a rectangular shape elongated in the second direction D2. Each negative electrode 120 includes a negative electrode current collector foil 122 and a negative electrode active material layer 124 provided on both surfaces of the negative electrode current collector foil 122. The negative electrode current collector foil 122 has a negative electrode tab 122n (see FIGS. 3 and 4) in which the negative electrode active material layer 124 is not provided. The negative electrode tab 122n protrudes toward the other side in the second direction D2.

The separator 130 insulates the positive electrode 110 from the negative electrode 120. The separator 130 is made from an insulating material, and has minute voids that allow penetration of ions. As shown in FIG. 5, the separator 130 is folded.

The separator 130 has a rectangular shape before being folded. The separator 130 is folded between the electrodes 110 and 120. The separator 130 includes a plurality of intervening portions 132a, a plurality of upper folded portions 132b, a plurality of lower folded portions 132c, and an outermost covering portion 132d.

Each intervening portion 132a is interposed between a pair of electrodes 110 and 120 adjacent to each other in one direction. That is, each intervening portion 132a has a function of insulating the positive electrode 110 and the negative electrode 120. Each intervening portion 132a is formed of a rectangular region.

The upper folded portions 132b connect an upper end portion of one of the plurality of intervening portions 132a and an upper end portion of the intervening portion 132a adjacent to the one intervening portion 132a on one side of the plurality of intervening portions 132a in one direction. In the present embodiment, the upper folded portion 132b is disposed above the positive electrode 110.

Each lower folded portion 132c connects a lower end portion of the one intervening portion of the plurality of intervening portions 132a and a lower end portion of the intervening portion 132a adjacent to the one intervening portion on the other side in one direction of the plurality of intervening portions 132a. In the present embodiment, the lower folded portion 132c is disposed below the negative electrode 120. In other words, the negative electrode 120 is disposed on the lower folded portion 132c.

The outermost covering portions 132d collectively cover the upper folded portions 132b and the lower folded portions 132c. More specifically, the outermost covering portion 132d covers all of the electrodes 110 and 120, all of the intervening portions 132a, all of the upper folded portions 132b, and all of the lower folded portions 132c while winding around the central axis parallel to the second direction D2. The terminal end 132e of the outermost covering portion 132d is set so as not to overlap the positive electrode active material layer 114 and the negative electrode active material layer 124 in one direction. In the present embodiment, the terminal end 132e of the outermost covering portion 132d is provided below each of the electrodes 110 and 120. The peripheral surfaces and bottom surfaces of the plurality of electrodes 110 and 120 and the separator 130 may or may not be covered with an insulating film. The peripheral surfaces and bottom surfaces of the plurality of electrodes 110, 120 and the separator 130 may be in direct contact with the case 200.

As shown in FIGS. 1 to 4, the case 200 includes a case body 210 and at least one partition portion 220.

The case body 210 has electrical insulation property at least on the surface facing the electrode assembly 100. The case body 210 surrounds the plurality of electrode assemblies 100.

The case body 210 includes a bottom wall portion 211, a peripheral sidewall portion 212, a hole 215, a lid 216, and a weld portion 217.

The bottom wall portion 211 is made from a resin composition. In the case body 210, the bottom wall portion 211 is positioned on one side in the third direction D3. The third direction D3 is orthogonal to both the first direction D1 and the second direction D2. The bottom wall portion 211 extends along the first direction D1 and the second direction D2. When viewed from the third direction D3, the bottom wall portion 211 has a rectangular outer shape.

The peripheral sidewall portion 212 is made from a resin composition and integrally formed with the bottom wall portion 211. The peripheral sidewall portion 212 extends upright in the third direction D3 from the peripheral edge of the bottom wall portion 211, and forms an opening OP that opens in the direction opposite to the bottom wall portion 211.

The peripheral sidewall portion 212 includes a pair of first wall portions 213 and a pair of second wall portions 214. The pair of first wall portions 213 is arranged in the first direction D1. The pair of first wall portions 213 extends along the second direction D2. The pair of second wall portions 214 are arranged in the second direction D2. The pair of second wall portions 214 extends along the first direction D1.

The hole 215 is provided to expose a part of the connection conductive member 310 to the outside of the case body 210. The hole 215 is closed by the connection conductive member 310. Specifically, the hole 215 is provided in the peripheral sidewall portion 212, and more specifically, is provided in the second wall portion 214.

In the present embodiment, the case body 210 has a plurality of holes 215 as the above-described holes 215. Among the plurality of holes 215, the external conductive member 320 is exposed from another hole 215 different from the hole 215 described above. In the present embodiment, the connection conductive member 310 is exposed from the two holes 215. These holes 215 may be provided so as to be continuous with each other.

The lid 216 closes the opening OP. In the present embodiment, at least a portion of the lid 216 facing the peripheral sidewall portion 212 is made from a resin composition. The lid 216 has a plate-like or film-like outer shape.

The lid 216 may be a stack including a resin layer made from the resin composition and a barrier layer. Specifically, the lid 216 may be a laminated film in which a barrier layer made of aluminum or the like is laminated on a resin layer. The lid 216 may be a plate-like member in which a metal plate such as aluminum is laminated on a resin layer. The barrier layer or metal plate may be disposed within the resin layer.

The weld portion 217 is formed by thermally welding the lid 216 and the peripheral sidewall portion 212 to each other. Instead of forming the weld portion 217, the lid 216 and the peripheral sidewall portion 212 may be joined to each other by other known joining methods such as an adhesive.

The partition portion 220 has electrical insulation property at least on the surface facing the electrode assembly 100. The partition portion 220 is positioned between the electrode assemblies 100 adjacent to each other to partition the accommodation space S of the case body 210. The case 200 according to the present embodiment includes a plurality of partition portions 220. The plurality of partition portions 220 includes a first partition portion 220A and a second partition portion 220B. The plurality of partition portions 220 may include three or more partition portions.

In the accommodation space S of the case body 210, a first compartment S1 and a second compartment S2 adjacent to the first compartment S1 with the partition portion 220 (first partition portion 220A) interposed therebetween are formed by the partition portion 220 (first partition portion 220A). In addition, a third compartment S3 adjacent to the first compartment S1 with the first compartment S1 and the second partition portion 220B interposed therebetween is formed by the second partition portion 220B in the accommodation space S. The third compartment S3 is positioned opposite to the second compartment S2 as seen from the first compartment S1.

Among the plurality of electrode assemblies 100, the first electrode assembly 100A is accommodated in the first compartment S1. The second electrode assembly 100B is accommodated in the second compartment S2. The third electrode assembly 100C is accommodated in the third compartment. An electrolyte solution is injected into the accommodation space S (the first compartment S1, the second compartment S2, and the third compartment S3). The electrolyte solution is not shown. The method of injecting the electrolyte solution is not particularly limited. The electrolyte solution may be injected from the opening OP before the opening OP is closed by the lid 216.

The partition portions 220 are made from a resin composition and integrally formed with the bottom wall portion 211 and the peripheral sidewall portion 212. In this embodiment, the plurality of partition portions 220 and the lid 216 may or may not be joined to each other by thermal welding.

In the present embodiment, examples of the above-described “integrally formed” method include a method in which molding and joining of each component are performed simultaneously in one step by a well-known method such as injection molding, and a method in which a plurality of components are separately formed and then joined to each other by a well-known joining method such as welding, or adhesion.

Here, a resin composition that may form the bottom wall portion 211, the peripheral sidewall portion 212, the lid 216, and the plurality of partition portions 220 in the present embodiment will be described.

The resin composition may contain, as a base polymer, polycarbonate, polyethylene, polypropylene, polyvinyl, polyamide, polyester, polyphenylene sulfide (PPS), polyphenylene ether, polystyrene, polycyclic olefin copolymer, acrylonitrile-butadiene-styrene copolymer, liquid crystal polymer (LCP), fluororesin, a mixture thereof, an alloy thereof, or a copolymer thereof. The base polymer is not limited to them.

The resin composition may contain, as a base polymer, polyolefin, liquid crystal polymer, or fluororesin. The polyolefin may include High-Density Polyethylene (HDPE). The High-Density Polyethylene, liquid crystal polymer, or fluororesin has a relatively low water vapor permeability. Therefore, the moisture permeability resistance of the case 200 including the resin composition containing them is improved.

The liquid crystal polymer may include structural units derived from an oligomer of hydroxybenzoic acid. The liquid crystal polymer may further contain two or more kinds selected from the group consisting of HNA (2,6-hydroxynaphthoic acid), TPA (terephthalic acid), IPA (isophthalic acid), HQ (hydroquinone), BP (biphenol), PET (polyethylene terephthalate) and PEN (polyethylene naphthalate), in addition to the oligomer of hydroxybenzoic acid, and may be copolymerized with the oligomer of hydroxybenzoic acid (HBA).

The fluororesin may be polytetrafluoroethylene (PTFE), polyvinylidene difluoride (PVDF), polychlorotrifluoroethylene (PCTFE), or a mixture thereof, or a copolymer thereof. The fluororesin is hydrophobic. Thus, relative to the total weight of the resin composition, the resin composition may contain, for example, about 20% by weight or less, about 15% by weight or less, about 10% by weight or less, about 3% by weight to about 10% by weight, about 5% by weight to about 10% by weight of fluororesin. When the content of the fluororesin falls within the above ranges, it is considered that the molded article made from the resin composition has an effect of blocking moisture from the surface of the molded article in contact with the outside air.

In the present embodiment, it is preferable that the base polymer of the resin composition constituting the lid 216 and the base polymer of the resin composition constituting the peripheral sidewall portion 212 and the plurality of partition portions 220 are the same. Thereby, these components are easily welded to each other. Consequently, the weld portion 217 can be easily formed. From the viewpoint of performing thermal welding, the base polymer is preferably polyethylene or polypropylene.

The resin composition may further contain an inorganic hygroscopic agent or graphite from the viewpoint of suppressing water vapor permeability. The resin composition may further contain a substance known as an existing moisture barrier substance in addition to graphite.

Next, the connection conductive member 310 and the external conductive member 320 will be described. In the present embodiment, the power storage module 1 includes a plurality of connection conductive members 310. The plurality of connection conductive members 310 includes a first connection conductive member 310A and a second connection conductive member 310B. The plurality of connection conductive members 310 may include three or more connection conductive members. In the present embodiment, the power storage module 1 includes the first external conductive member 320A and the second external conductive member 320B as the external conductive member 320.

The connection conductive member 310 (the first connection conductive member 310A and the second connection conductive member 310B) includes a first end portion 311A, a second end portion 311B, a first inner surface portion 312A, a second inner surface portion 312B, a first outer surface portion 313A, and a second outer surface portion 313B.

In the first connection conductive member 310A, the first end portion 311A is an end portion, located at one side in the first direction D1, of the first connection conductive member 310A, and is embedded in the peripheral sidewall portion 212 (one of the second wall portions 214) of the case body 210. The second end portion 311B is an end portion, located at the other side in the first direction D1, of the first connection conductive member 310A, and is embedded in the peripheral sidewall portion 212 (one of the second wall portions 214) of the case body 210.

In the first connection conductive member 310A, the first inner surface portion 312A is exposed to the first compartment S1 and electrically connected to the electrode tab (negative electrode tab 122n) of the first electrode assembly 100A. The second inner surface portion 312B is exposed to the second compartment S2 and electrically connected to the electrode tab (positive electrode tab 112p) of the second electrode assembly 100B.

In the second connection conductive member 310B, the first end portion 311A is an end portion, located at one side in the first direction D1, of the second connection conductive member 310B, and is embedded in the peripheral sidewall portion 212 (the other second wall portion 214) of the case body 210. The second end portion 311B is an end portion, located at the other side in the first direction D1, of the second connection conductive member 310B, and is embedded in the peripheral sidewall portion 212 (the other second wall portion 214) of the case body 210.

In the second connection conductive member 310B, the first inner surface portion 312A is exposed to the first compartment S1 and electrically connected to the electrode tab (positive electrode tab 112p) of the first electrode assembly 100A. The second inner surface portion 312B is exposed to the third compartment S3 and electrically connected to the electrode tab (negative electrode tab 122n) of the third electrode assembly 100C.

In each of the connection conductive members 310, the first outer surface portion 313A is located opposite to the first inner surface portion 312A, and is exposed to the outside of the case body 210 through the hole 215. Each of the connection conductive members 310 is provided with a pressure release valve 314 capable of releasing the pressure on the first inner surface portion 312A side to the first outer surface portion 313A side.

In each of the connection conductive members 310, the second outer surface portion 313B is located opposite to the second inner surface portion 312B and is exposed to the outside of the case body 210 through the other hole 215. Each of the connection conductive members 310 is provided with another pressure release valve 315 capable of releasing the pressure on the second inner surface portion 312B side to the first outer surface portion 313A side.

The first external conductive member 320A is located at a side of the third electrode assembly 100C in the second direction D2, and is electrically connected to the third electrode assembly 100C. The second external conductive member 320B is located at a side of the second electrode assembly 100B in the second direction D2, and is electrically connected to the second electrode assembly 100B.

Each of the external conductive members 320 includes a third inner surface portion 321, an external connection surface portion 322, and an embedded end portion 323.

In the first external conductive member 320A, the third inner surface portion 321 is exposed to the accommodation space S (third compartment S3), and is electrically connected to the electrode tab (positive electrode tab 112p) of the third electrode assembly 100C. In the second external conductive member 320B, the third inner surface portion 321 is exposed to the accommodation space S (second compartment S2), and is electrically connected to the electrode tab (negative electrode tab 122n) of the second electrode assembly 100B.

In each of the external conductive members 320, the external connection surface portion 322 is exposed to the outside of the case body 210 in the first direction D1. The embedded end portion 323 is an end portion opposite to the external connection surface portion 322 in the first direction D1, and is embedded in the case body 210.

Each external conductive member 320 further includes a third outer surface portion 324. The third outer surface portion 324 is located opposite to the third inner surface portion 321. The third outer surface portion 324 is exposed to the outside of the case body 210 through one of the plurality of holes 215. Each of the external conductive members 320 is provided with another pressure release valve 325 capable of releasing the pressure on the third inner surface portion 321 side to the third outer surface portion 324 side.

Each of the connection conductive members 310 and each of the external conductive members 320 are made of a metal such as stainless steel, aluminum, or copper. The method of partially embedding the connection conductive members 310 and the external conductive members 320 in the peripheral sidewall portion 212 (the second wall portion 214) of the case body 210 is not particularly limited. For example, a resin composition as a material of the peripheral sidewall portion 212 (the second wall portion 214) of the case body 210 may be injection molded so as to cover a part of each of the connection conductive members 310 and each of the external conductive members 320.

In the present embodiment, the power storage module 1 further includes a plurality of current collector members 400. The plurality of current collector members 400 are disposed between the positive electrode tab 112p of each electrode assembly 100 and the connection conductive member 310 or the external conductive member 320, and between the negative electrode tab 122n of each electrode assembly 100 and the connection conductive member 310 or the external conductive member 320. Each current collector member 400 is joined to each positive electrode tab 112p or each negative electrode tab 122n by welding. Each of the current collector members 400 is joined to the first inner surface portion 312A, the second inner surface portion 312B, or the third inner surface portion 321 by welding.

The plurality of current collector members 400 may include a metallic material such as aluminum or copper, for example. The power storage module 1 may not include the current collector member 400. When the current collector member 400 is not included, each of the positive electrode tabs 112p and each of the negative electrode tabs 122n may be directly joined to the adjacent first inner surface portion 312A, the second inner surface portion 312B, or the third inner surface portion 321 by welding.

As described above, the power storage module 1 according to the first embodiment of the present disclosure includes a plurality of electrode assemblies 100, a case 200, and at least one connection conductive member 310. The connection conductive member 310 includes a first end portion 311A, a second end portion 311B, a first inner surface portion 312A, and a second inner surface portion 312B. The first end portion 311A is an end portion, located at one side in the first direction D1, of the connection conductive member 310, and embedded in the case body 210. The second end portion 311B is an end portion, located at the other side in the first direction D1, of the connection conductive member 310, and embedded in the case body 210. The first inner surface portion 312A is exposed to the first compartment S1 and electrically connected to a first electrode assembly 100A contained in the first compartment S1 among the plurality of electrode assemblies 100. The second inner surface portion 312B is exposed to the second compartment S2 and electrically connected to a second electrode assembly 100B contained in the second compartment S2 among the plurality of electrode assemblies 100.

According to the above configuration, the connection conductive member 310 electrically connects the first electrode assembly 100A and the second electrode assembly 100B and is at least partially embedded in the case body 210 in the first direction D1. Therefore, the size of the power storage module 1 can be reduced.

Further, in the first embodiment of the present disclosure, the case body 210 has a hole 215 provided to expose a part of the connection conductive member 310 to the outside of the case body 210 and closed by the connection conductive member 310. The connection conductive member 310 further includes a first outer surface portion 313A located opposite to the first inner surface portion 312A and exposed to the outside of the case body 210 from the hole 215. The connection conductive member 310 is provided with a pressure release valve 314 capable of releasing the pressure on the first inner surface portion 312A side to the first outer surface portion 313A side.

According to the above configuration, since the pressure release valve 314 is provided in the connection conductive member 310, the safety of the power storage module 1 can be further enhanced. Further, as compared with the case where the pressure release valve is provided in the case body 210 having electrical insulation property, the pressure release valve can be easily provided in the power storage module 1.

The power storage module 1 according to the first embodiment of the present disclosure further includes an external conductive member 320. The external conductive member 320 is located at a side of a third electrode assembly 100C in the second direction D2, and electrically connected to the third electrode assembly 100C, where the third electrode assembly is located at an endmost position in the first direction D1, among the plurality of electrode assemblies 100. The external conductive member 320 includes a third inner surface portion 321, an external connection surface portion 322, and an embedded end portion 323. The third inner surface portion 321 is exposed to the accommodation space S and electrically connected to the third electrode assembly 100C. The external connection surface portion 322 is exposed to the outside of the case body 210 in the first direction D1. The embedded end portion 323 is an end portion located opposite to the external connection surface portion 322 in the first direction D1, and embedded in the case body 210.

According to the above configuration, the external connection surface portion 322 is utilized to facilitate connection with another conductive member (for example, an external connection surface portion of another power storage module) in the first direction D1. Further, since the external conductive member 320 is partially embedded in the case body 210, the size of the power storage module 1 can be further reduced.

Further, in the first embodiment of the present disclosure, the case body 210 includes a bottom wall portion 211, a peripheral sidewall portion 212, a lid 216, and a weld portion 217. The bottom wall portion 211 is made from a resin composition and located at one side in the third direction D3. The third direction D3 is orthogonal to both the first direction D1 and the second direction D2. The peripheral sidewall portion 212 is made from a resin composition, formed integrally with the bottom wall portion 211, extends upright in the third direction D3 from the peripheral edge of the bottom wall portion 211, and forms an opening OP that opens in the direction opposite to the bottom wall portion 211. The lid 216 closes the opening OP, and at least a portion of the lid 216 that faces the peripheral sidewall portion 212 is made from a resin composition. The weld portion 217 is formed by thermally welding the lid 216 and the peripheral sidewall portion 212 to each other.

According to the above configuration, since both the case body 210 and the lid 216 are made from the resin composition, the weld portion 217 can be easily formed. Consequently, the opening OP can be easily sealed.

### Second Embodiment

Hereinafter, a power storage module according to a second embodiment of the present disclosure will be described. In the power storage module according to the second embodiment of the present disclosure, the structure of the lid is mainly different from that of the power storage module according to the first embodiment of the present disclosure. Therefore, in the power storage module according to the second embodiment of the present disclosure, description of the same configuration and effect as in the first embodiment will not be repeated.

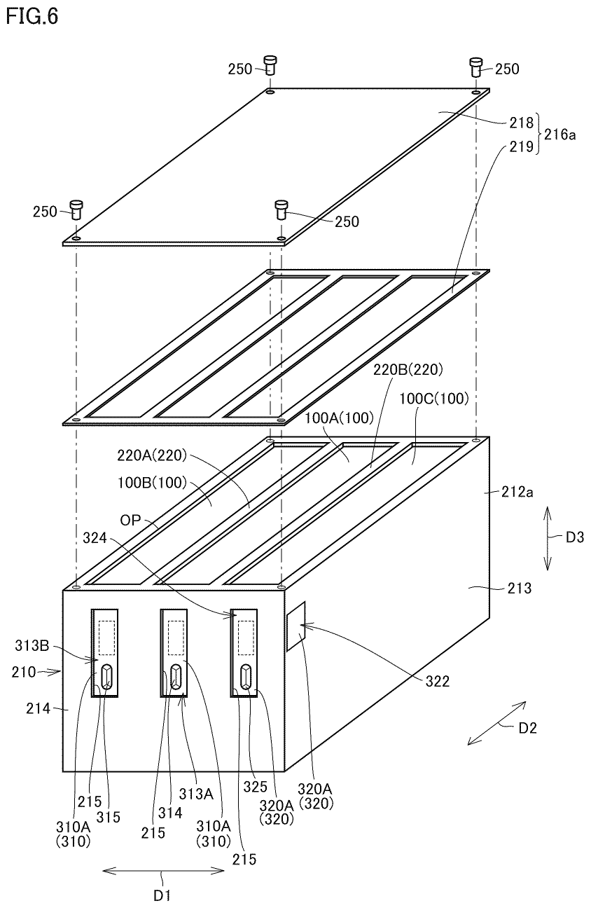

FIG. 6 is a partially exploded perspective view of a power storage module according to a second embodiment. As shown in FIG. 6, in the second embodiment of the present disclosure, the lid 216a includes a lid body 218 and a gasket 219. The gasket 219 is sandwiched between the lid body 218 and the peripheral sidewall portion 212a. This makes it possible to enhance the sealing performance of the case body 210 by a relatively simple method.

The lid body 218 may have a similar configuration to the lid 216 in the first embodiment. From the viewpoint of increasing the rigidity, the lid body 218 is preferably a plate-like member including a metal plate. The gasket 219 may be a plate-like member or a linear member such as an O-ring. Gaskets and 219 may be further disposed between lid body 218 and each partition portion 220. A portion of the peripheral sidewall portion 212a that contacts the gasket 219 may have a shape (for example, a groove-shaped outer shape) that conforms to the outer shape of the gasket 219.

The lid 216a may further include a plurality of fastening members 250. The fastening member 250 is, for example, a bolt. The lid body 218 and the peripheral sidewall portion 212a are fixed to each other by a plurality of fastening members 250.

### Third Embodiment

Hereinafter, a power storage module according to a third embodiment of the present disclosure will be described. In the power storage module according to the third embodiment of the present disclosure, the structure of the lid body is mainly different from that of the power storage module according to the second embodiment of the present disclosure. Therefore, in the power storage module according to the third embodiment of the present disclosure, description of the same configuration and effect as those of the second embodiment will not be repeated.

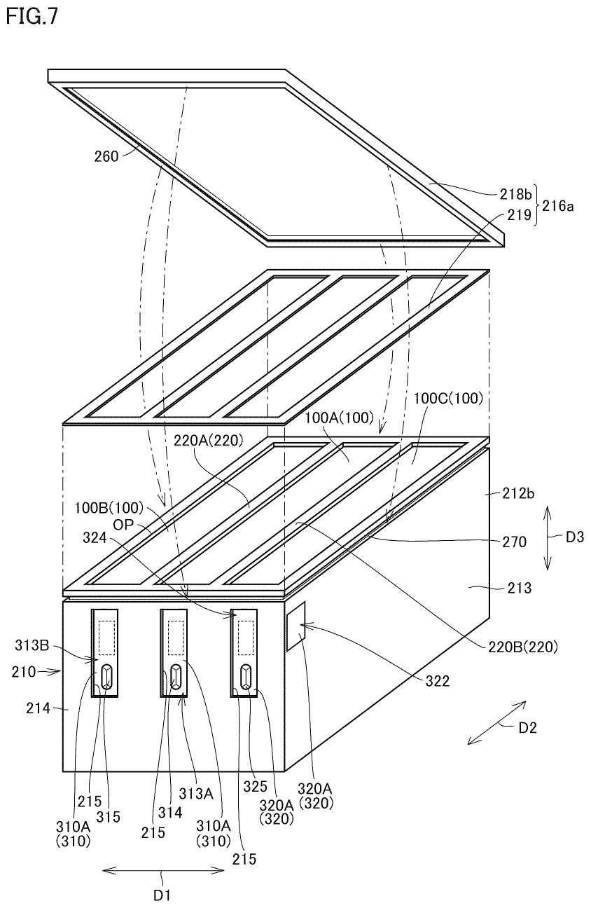

FIG. 7 is a partially exploded perspective view of a power storage module according to a third embodiment. As shown in FIG. 7, in the present embodiment, the lid body 218b has a claw portion 260 provided along the peripheral edge. The peripheral sidewall portion 212b has a depressed portion 270 provided along the outer surface of the peripheral sidewall portion 212b. The lid body 218b is fixed by fitting the claw portion 260 to the depressed portion 270. Further, in the present embodiment, a weight made of another member may be provided on the center portion of the lid body 218b. Thereby, deformation of the central portion of the lid body 218b can be suppressed by using the fitting portion between the claw portion 260 and the depressed portion 270 as a fulcrum.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power storage module comprising:
a plurality of electrode assemblies arranged in a first direction;
a case housing the plurality of electrode assemblies; and
at least one connection conductive member that is located at a side of the plurality of electrode assemblies in a second direction orthogonal to the first direction, and electrically connects together the electrode assemblies adjacent to each other, wherein
the case includes:
a case body having electrical insulation property and surrounding the plurality of electrode assemblies; and
at least one partition portion having electrical insulation property and located between the electrode assemblies adjacent to each other to partition an accommodation space of the case body,
in the accommodation space of the case body, the partition portion forms a first compartment and a second compartment adjacent to the first compartment with the partition portion interposed between the first compartment and the second compartment,
the connection conductive member includes a first end portion, a second end portion, a first inner surface portion, and a second inner surface portion,
the first end portion is an end portion, located at one side in the first direction, of the connection conductive member, and embedded in the case body,
the second end portion is an end portion, located at the other side in the first direction, of the connection conductive member, and embedded in the case body,
the first inner surface portion is exposed to the first compartment and electrically connected to a first electrode assembly contained in the first compartment, among the plurality of electrode assemblies, and
the second inner surface portion is exposed to the second compartment and electrically connected to a second electrode assembly contained in the second compartment, among the plurality of electrode assemblies.

2. The power storage module according to claim 1, wherein
the case body includes a hole provided to expose a part of the connection conductive member to an outside of the case body, and closed by the connection conductive member,
the connection conductive member further includes a first outer surface portion located opposite to the first inner surface portion and exposed to the outside of the case body from the hole, and
the connection conductive member is provided with a pressure release valve capable of releasing a pressure on the first inner surface portion toward the first outer surface portion.

3. The power storage module according to claim 1, further comprising an external conductive member located at a side of a third electrode assembly in the second direction, and electrically connected to the third electrode assembly, the third electrode assembly being located at an endmost position in the first direction among the plurality of electrode assemblies,
the external conductive member includes a third inner surface portion, an external connection surface portion, and an embedded end portion,
the third inner surface portion is exposed to the accommodation space and electrically connected to the third electrode assembly,
the external connection surface portion is exposed to an outside of the case body in the first direction, and
the embedded end portion is an end portion located opposite to the external connection surface portion in the first direction, and embedded in the case body.

4. The power storage module according to claim 1, wherein
the case body includes:
a bottom wall portion made from a resin composition and located at one side in a third direction orthogonal to both the first direction and the second direction;
a peripheral sidewall portion made from a resin composition, formed integrally with the bottom wall portion, extending upright in the third direction from a peripheral edge of the bottom wall portion, and forming an opening that opens in a direction opposite to the bottom wall portion;
a lid closing the opening, wherein at least a portion of the lid that faces the peripheral sidewall portion is made from a resin composition; and
a weld portion formed by thermally welding the lid and the peripheral sidewall portion to each other.

5. The power storage module according to claim 1,
the case body includes:
a bottom wall portion located at one side in a third direction orthogonal to both the first direction and the second direction;
a peripheral sidewall portion formed integrally with the bottom wall portion, extending upright in the third direction from a peripheral edge of the bottom wall portion, and forming an opening that opens in a direction opposite to the bottom wall portion; and
a lid closing the opening, and
the lid includes:
a lid body; and
a gasket sandwiched between the lid body and the peripheral sidewall portion.

6. The power storage module according to claim 1, further comprising an external conductive member located at a side of a third electrode assembly in the second direction, and electrically connected to the third electrode assembly, the third electrode assembly being located at an endmost position in the first direction among the plurality of electrode assemblies,
the external conductive member includes a third inner surface portion, an external connection surface portion, and an embedded end portion,
the third inner surface portion is exposed to the accommodation space and electrically connected to the third electrode assembly,
the external connection surface portion is exposed to an outside of the case body in the first direction,
the embedded end portion is an end portion located opposite to the external connection surface portion in the first direction, and embedded in the case body,
the case body includes:
a bottom wall portion made from a resin composition and located at one side in a third direction orthogonal to both the first direction and the second direction;
a peripheral sidewall portion made from a resin composition, formed integrally with the bottom wall portion, extending upright in the third direction from a peripheral edge of the bottom wall portion, and forming an opening that opens in a direction opposite to the bottom wall portion;
a lid closing the opening, wherein at least a portion of the lid that faces the peripheral sidewall portion is made from a resin composition;
a weld portion formed by thermally welding the lid and the peripheral sidewall portion to each other; and
a hole provided to expose a part of the connection conductive member to the outside of the case body, and closed by the connection conductive member,
the connection conductive member further includes a first outer surface portion located opposite to the first inner surface portion and exposed to the outside of the case body from the hole, and
the connection conductive member is provided with a pressure release valve capable of releasing a pressure on the first inner surface portion toward the first outer surface portion.

7. The power storage module according to claim 1, further comprising an external conductive member located at a side of a third electrode assembly in the second direction, and electrically connected to the third electrode assembly, the third electrode assembly being located at an endmost position in the first direction among the plurality of electrode assemblies,
the external conductive member includes a third inner surface portion, an external connection surface portion, and an embedded end portion,
the third inner surface portion is exposed to the accommodation space and electrically connected to the third electrode assembly,
the external connection surface portion is exposed to an outside of the case body in the first direction,
the embedded end portion is an end portion located opposite to the external connection surface portion in the first direction, and embedded in the case body,
the case body includes:
a bottom wall portion located at one side in a third direction orthogonal to both the first direction and the second direction;
a peripheral sidewall portion formed integrally with the bottom wall portion, extending upright in the third direction from a peripheral edge of the bottom wall portion, and forming an opening that opens in a direction opposite to the bottom wall portion;
a lid closing the opening; and
a hole provided to expose a part of the connection conductive member to the outside of the case body, and closed by the connection conductive member,
the lid includes:
a lid body; and
a gasket sandwiched between the lid body and the peripheral sidewall portion,
the connection conductive member further includes a first outer surface portion located opposite to the first inner surface portion and exposed to the outside of the case body from the hole, and
the connection conductive member is provided with a pressure release valve capable of releasing a pressure on the first inner surface portion toward the first outer surface portion.
